(19) United States
(12) Patent Application Publication
(10) Pub. No.: US 2016/0059542 A1
(43) Pub. Date: Mar. 3, 2016

(54) SCREEN PRINTING APPARATUS AND SCREEN PRINTING METHOD

(71) Applicant: Panasonic Intellectual Property Management Co., Ltd., Osaka (JP)

(72) Inventors: Hideki UCHIDA, Yamanashi (JP); Masayuki MANTANI, Yamanashi (JP); Michinori TOMOMATSU, Yamanashi (JP)

(21) Appl. No.: 14/828,840

(22) Filed: Aug. 18, 2015

(30) Foreign Application Priority Data
Sep. 1, 2014 (JP) 2014-176836

(51) Int. Cl. B41F 15/44

(52) U.S. Cl. CPC B41F 15/44

(57) ABSTRACT

A screen printing apparatus includes: a mask plate having a pattern hole formed according to an arrangement of an electrode of a board; a squeegee base that moves along a first horizontal direction above the mask plate; a squeegee that is held by the squeegee base, and prints paste through the pattern hole onto the board abutting on a lower surface of the mask plate by moving together with the squeegee base and sliding on the mask plate in a squeegeeing direction along the first horizontal direction; and a paste supplying portion that moves together with the squeegee base and supplies the paste to the mask plate. The paste supplying portion supplies the paste to the mask plate while the squeegee is sliding on the mask plate.

### CROSS-REFERENCE TO RELATED APPLICATION(S)

This application is based on and claims priority from Japanese Patent Application No. 2014-176836 filed on Sep. 1, 2014, the entire contents of which are incorporated herein by reference.

### BACKGROUND

1. Field of the Invention

One or more embodiments of the present invention relate to a screen printing apparatus and a screen printing method for printing paste such as cream solder or conductive paste onto a board.

2. Description of Related Art

In the field of electronic component mounting, there is a screen printing apparatus that prints paste such as cream solder onto a board by causing the board to abut on the lower surface of a mask plate having pattern holes formed according to the electrode arrangement of the board and sliding a squeegee on the mask plate under this condition. The paste supplied onto the mask plate gradually decreases as printing is repeated. In view of the circumstances, for example, a method of supplying paste onto a mask plate is described in JP-A-2013-233673.

In the example shown in JP-A-2013-233673, a paste supplying syringe (paste supplying portion) storing paste is attached to a squeegee base holding a squeegee. When the paste remaining on the mask plate is decreased to a predetermined amount, the paste supplying syringe is moved together with the squeegee to a position above one side portion of the mask plate corresponding to a sliding start position of the squeegee, and in this position, a necessary amount of paste is ejected toward the one side portion of the mask plate from the ejection port of the paste supplying syringe.

### SUMMARY

However, according to the above-described technique, during supply of the paste, printing is interrupted since the squeegee is not slid, so that productivity decreases. Moreover, during supply of the paste, the old paste remains still on the mask plate and hence gradually hardens. In addition thereto, the paste newly supplied onto the mask plate tends to be high in viscosity since it had been stored in the syringe until then. With the paste that is high in viscosity (that is, hard), it is difficult to fill the pattern holes of microscopic diameters, which becomes a factor that causes a printing failure. For this reason, prior to the resumption of printing, it is necessary to blend the new and old pastes by agitating them by reciprocating the squeegee over a plurality of number of times. Therefore, it is impossible to quickly start printing after paste supply is finished, which leads to a further reduction in productivity.

Accordingly, an object of one or more embodiments of the present invention is to provide a screen printing apparatus and a screen printing method capable of supplying paste onto the mask plate while preventing reduction in productivity.

One or more embodiments provide a screen printing apparatus including: a mask plate having a pattern hole formed according to an arrangement of an electrode of a board; a squeegee base that moves along a first horizontal direction above the mask plate; a squeegee that is held by the squeegee base, and prints paste through the pattern hole onto the board abutting on a lower surface of the mask plate by moving together with the squeegee base and sliding on the mask plate in a squeegeeing direction along the first horizontal direction; and a paste supplying portion that moves together with the squeegee base and supplies the paste to the mask plate, wherein the paste supplying portion supplies the paste to the mask plate while the squeegee is sliding on the mask plate.

One or more embodiments provide a screen printing method for printing paste onto a board by a squeegee held by a squeegee base that moves along a first horizontal direction above a mask plate having a pattern hole formed according to an arrangement of an electrode of the board, the method including: causing the board to abut on a lower surface of the mask plate; and printing the paste through the pattern hole onto the board abutting on the lower surface of the mask plate by the squeegee which is moving together with the squeegee base and sliding on the mask plate in a squeegeeing direction along the first horizontal direction, wherein while the squeegee is sliding on the mask plate, the paste is supplied to the mask plate from a paste supplying portion which is moving together with the squeegee base.

According to one or more embodiments, it is possible to supply paste onto the mask plate while preventing reduction in productivity.

### BRIEF DESCRIPTION OF THE DRAWINGS

FIG. 1 is a side view of a screen printing apparatus in an embodiment of the present invention;

FIG. 2 is a plan view of the screen printing apparatus in the embodiment of the present invention;

FIG. 3 is a structure explanatory view of a paste supplying portion and a paste supplying portion moving mechanism that the screen printing apparatus is provided with in the embodiment of the present invention;

FIGS. 4A and 4B are structure explanatory views of the paste supplying portion that the screen printing apparatus is provided with in the embodiment of the present invention;

FIGS. 5A, 5B and 5C are structure explanatory views of a sensor unit for paste remaining amount detection that the screen printing apparatus is provided with in the embodiment of the present invention;

FIG. 6 is a function explanatory view of the sensor unit for paste remaining amount detection that the screen printing apparatus is provided with in the embodiment of the present invention;

FIG. 7 is a block diagram showing the structure of a control system of the screen printing apparatus in the embodiment of the present invention;

FIG. 8 is a flowchart of a screen printing method in the embodiment of the present invention;

FIGS. 9A, 9B and 9C are operation explanatory views of the screen printing method in the embodiment of the present invention;

FIG. 10 is a flowchart of paste replenishment processing in the embodiment of the present invention;

FIGS. 11A, 11B, 11C and 11D are operation explanatory views of the paste replenishment work in the embodiment of the present invention;

FIGS. 12A, 12B, 12C and 12D are operation explanatory views of the paste replenishment work in the embodiment of the present invention; and

FIGS. 13A and 13B are operation explanatory views of the paste replenishment work in another embodiment of the present invention.

### DETAILED DESCRIPTION

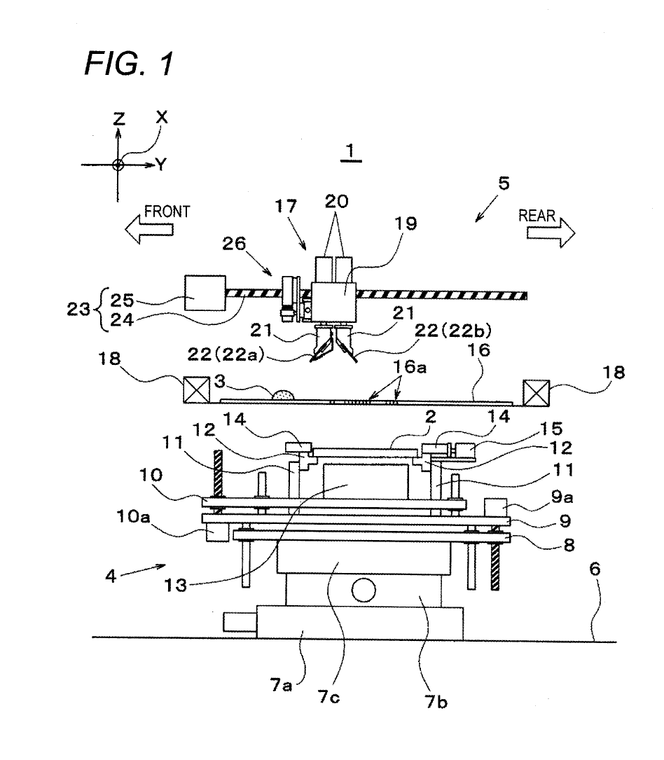

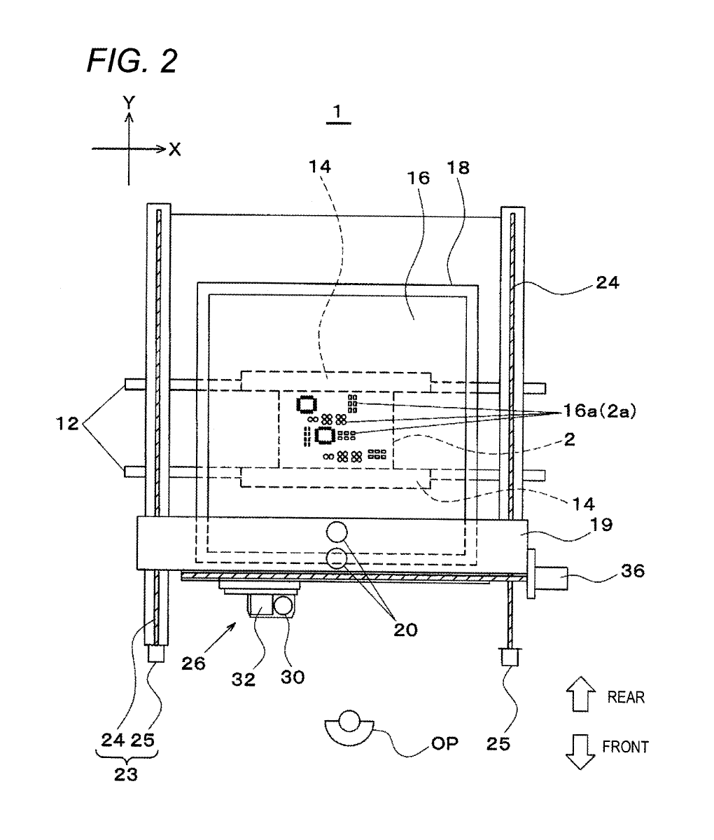

Referring first to FIG. 1, a screen printing apparatus 1 in an embodiment of the present invention will be described. The screen printing apparatus 1 has the function of printing paste 3 to electrodes 2a (FIG. 2) formed on a board 2, and includes a board positioning portion 4 and a paste printing portion 5. Examples of the paste 3 include a viscous material such as solder paste and conductive paste. Hereinafter, the conveyance direction of the board 2 is defined as an X direction (second horizontal direction), and a direction orthogonal to the X direction within a horizontal plane is defined as a Y direction (first horizontal direction). Moreover, a direction orthogonal to an X-Y plane is defined as a Z direction. Further, the left side of the plane of FIG. 1 is defined as the “front”, and the right side of the plane thereof, as the “rear”. As shown in FIG. 2, when performing maintenance work including replenishment of the paste 3, an operator OP accesses the screen printing apparatus 1 from the front.

Next, the board positioning portion 4 will be described. A Y-axis table 7a, an X-axis table 7b and a θ-axis table 7c are provided in stacked state on a base 6. The Y-axis table 7a moves the X-axis table 7b along the Y direction, and the X-axis table 7b moves the θ-axis table 7c along the X direction. To the top surface of the θ-axis table 7c, a flat base table 8 is attached so as to be horizontally rotatable with the Z direction as the axial center. The θ-axis table 7c rotates the base table 8 horizontally.

Above the base table 8, a first lifting table 9 and a second lifting table 10 are provided in this order from below. The first lifting table 9 moves up and down with respect to the base table 8 by the driving of a first lifting motor 9a. The second lifting table 10 moves up and down with respect to the first lifting table 9 by the driving of a second lifting motor 10a.

From the first lifting table 9, a pair of conveyer supporting members 11 extend upward through the second lifting table 10. By the pair of conveyer supporting members 11, a pair of conveyers 12 facing each other in the Y direction are supported. As shown in FIG. 2, the conveyers 12 extend in the X direction, and convey the board 2 in the X direction to position it in a predetermined position.

In FIG. 1, a board supporting portion 13 is provided on the top surface of the second lifting table 10 at a position between the pair of conveyer supporting members 11. The board supporting portion 13 moves up together with the second lifting table 10 by the driving of the second lifting motor 10a to thereby support the board 2 on the conveyers 12 from below.

Above the conveyers 12, a pair of clamping members 14 are provided. One clamping member 14 (the right side in FIG. 1) is linked to the rod of a first cylinder 15. By driving the first cylinder 15 so that the rod projects and recedes, the one clamping member 14 moves along the Y direction with respect to the other clamping member 14 (the left side of in FIG. 1). Thereby, the pair of clamping members 14 sandwich and hold the board 2 having moved up to a predetermined clamping position.

By driving the Y-axis table 7a, the X-axis table 7b and the θ-axis table 7c under a condition where the board 2 is held by the clamping members 14, the board 2 is positioned within the horizontal plane. Thereafter, the board supporting portion 13 moves up together with the first lifting table 9 by the driving of the first lifting motor 9a, whereby the board 2 abuts on the lower surface of a mask plate 16 described later.

Next, the paste printing portion 5 will be described. The paste printing portion 5 includes the mask plate 16 provided above the board positioning portion 4 and a squeegee unit 17 provided further above the mask plate 16. The mask plate 16 is a rectangular plate member extending on the X-Y plane, and held by a frame-form mask holder 18. This mask plate 16 has a plurality of pattern holes 16a formed so as to vertically pass therethrough according to the arrangement of the electrodes 2a of the board 2. Moreover, the paste 3 is supplied onto the mask plate 16.

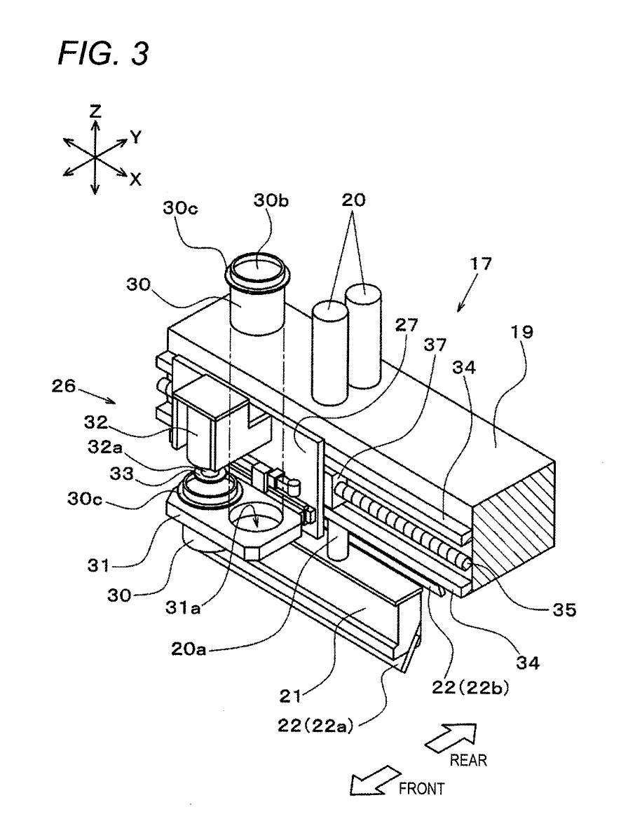

In FIGS. 1 and 3, the squeegee unit 17 includes a squeegee base 19, a pair of squeegee lifting mechanisms 20 held by the squeegee base 19, a pair of squeegee holders 21 linked to rods 20a extending from below the squeegee lifting mechanisms 20, and a pair of squeegees 22 held by the squeegee holders 21. The pair of squeegees 22 have a plate form, and are held by the squeegee base 19 through the squeegee lifting mechanisms 20 and the squeegee holders 21 so as to slanted toward respective squeegeeing directions. By driving the squeegee lifting mechanisms 20, the pair of squeegees 22 move up and down individually. Hereinafter, the squeegee disposed on the front side will be referred to as “a first squeegee 22a”, and the squeegee disposed on the rear side will be referred to as “a second squeegee 22b”. When it is not necessary to distinguish the two squeegees from each other, they will be referred to as “squeegee 22”.

In FIGS. 1 and 2, the squeegee unit 17 is movable along the Y direction by a unit moving mechanism 23. The unit moving mechanism 23 is provided with a pair of ball screws 24 extending in the Y direction and a first driving motor 25 that rotates the ball screws 24. As shown in FIG. 2, the pair of ball screws 24 are screwed into both end portions of the squeegee base 19. By driving the first driving motor 25 to rotate the ball screws 24 normally and in reverse, the squeegee base 19 moves along the first horizontal direction (Y direction) above the mask plate 16.

By driving the first driving motor 25 with the squeegee 22 being in contact with the mask plate 16, the squeegee 22 moves along the Y direction together with the squeegee base 19. Thereby, the squeegee 22 slides on the mask plate 16 in its squeegeeing direction, and the paste 3 is printed onto the board 2 abutting on the lower surface of the mask plate 16, through the pattern holes 16a. As described above, by the squeegee 22 moving along the Y direction together with the squeegee base 19 and sliding on the mask plate 16 supplied with the paste 3 in the squeegeeing direction, the paste 3 is printed onto the board 2 abutting on the lower surface of the mask plate 16, through the pattern holes 16a. In the embodiment, the squeegeeing direction of the first squeegee 22a corresponds to a direction from the front to the rear (the lift side to the right side in FIG. 1), and the squeegeeing direction of the second squeegee 22b corresponds to a direction from the rear to the front (the right side to the left side in FIG. 1).

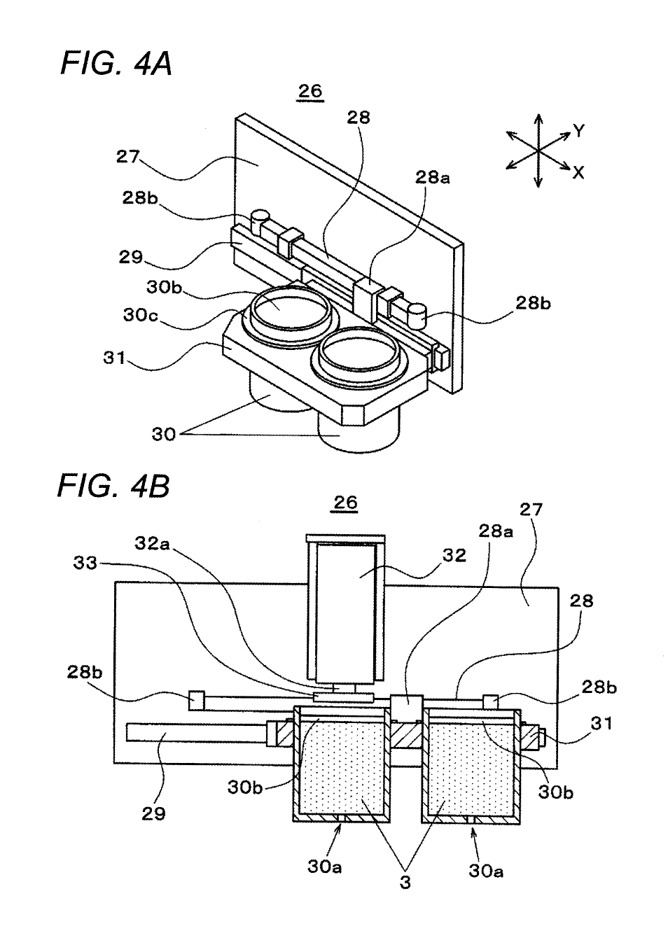

In FIGS. 1, 2, 3, 4A and 4B, a paste supplying portion 26 is provided on the surface on the front side (front surface) of the squeegee base 19. Hereinafter, a detailed structure of the paste supplying portion 26 will be described. In FIG. 4A, a flat plate member 27 is provided with a second cylinder 28 (for example, a rodless cylinder) extending in the X direction and a guide member 29 extending in the X direction below the second cylinder 28. The second cylinder 28 is provided with a block-form movable member 28a that is movable along the X direction, and moves the movable member 28a along the X direction by supplying and exhausting air through ports 28b provided on both end portions of the second cylinder 28.

To the guide member 29, a pot holding portion 31 holds pots 30, and is attached so as to be movable along the X direction. Further, the pot holding portion 31 is linked to the movable member 28a. By driving the second cylinder 28, the pot holding portion 31 moves along the X direction together with the movable member 28a.

Each of the pots 30 is formed mainly of a cylindrical container that is open at the top, and the paste 3 is accommodated thereinside. The pot 30 is covered with an inner lid 30b from above and thereby being sealed in a state in which the paste 3 is accommodated therein. At the bottom of each pot 30, an ejection port 30a capable of ejecting the paste 3 downward is formed. The ejection port 30a is situated on the front side when viewed from the side of the second squeegee 22b disposed on the rear. In other words, the ejection port 30a is situated ahead of the second squeegee 22b in the squeegeeing direction of the second squeegee 22b.

In FIG. 3, the pot holding portion 31 is made of a horizontal plate member, and a plurality of (two in this example) insertion holes 31a through which the pots 30 are insertable are provided in parallel in the X direction. A brim portion 30c provided on the periphery of the pot 30 is made to abut on the rim portion of the insertion hole 31a, whereby the pot 30 is held by the pot holding portion 31. The pot holding portion 31 is capable of holding the two pots 30 in parallel in the X direction.

As shown in FIGS. 3 and 4B, a third cylinder 32 is provided in a position above the pot holding portion 31 on the plate member 27. To the lower end portion of the rod 32a of the third cylinder 32, a disk-like pad member 33 is fixed. The desired pot 30 held by the pot holding portion 31 is positioned below the pad member 33, and under this condition, the third cylinder 32 is driven to push down the inner lid 30b by the pad member 33, whereby the paste 3 in the pot 30 is pressurized. Thereby, the paste 3 is ejected onto the mask plate 16 through the ejection port 30a. For the sake of convenience, in FIG. 4A, an illustration of the third cylinder 32 is omitted.

When the paste 3 accommodated in one pot 30 of the two pots 30 held by the pot holding portion 31 is all gone, the pot holding portion 31 is slid along the X direction by the second cylinder 28, and the other pod 30 is positioned below the pad member 33. Consequently, the pot to supply the paste 3 can be switched to the other pod 30.

As described above, the paste supplying portion 26 includes the plate member 27, the second cylinder 28, the guide member 29, the pots 30, the pot holding portion 31, the third cylinder 32 and the pad member 33, moves together with the squeegee base 19, and supplies the paste 3 onto the mask plate 16. Moreover, the paste supplying portion 26 has the ejection port 30a for ejecting the paste 3 ahead of the the second squeegee 22b in the squeegeeing direction of the second squeegee 22b. Since the paste supplying portion 26 is situated on the front side of the squeegee base 19, the operator OP can easily change the pots 30.

Next, a structure for moving the paste supplying portion 26 along the X direction will be described. In FIG. 3, on the surface on the front side of the squeegee base 19, a pair of guide members 34 extending in the X direction in parallel and a ball screw 35 extending in the X direction in parallel with the guide members 34 in a position between the pair of guide members 34 are provided. The ball screw 35 is rotated by a second driving motor 36 (FIG. 2) provided on an end portion of the squeegee base 19. On the ball screw 35, a block member 37 is screwed. The block member 37 reciprocates along the X direction along the guide members 34 by normal and reverse rotation of the ball screw 35 by the second driving motor 36.

To the block member 37, the above-described plate member 27 is fixed. Therefore, by driving the second driving motor 36, the paste supplying portion 26 moves along the X direction together with the block member 37 along the guide members 34. In the above-described structure, the guide members 34, the ball screw 35, the second driving motor 36 and the block member 37 serve as a paste supplying portion moving mechanism which moves the paste supplying portion 26 along the second horizontal direction (X direction). Moreover, the paste supplying portion 26 is attached to the squeegee base 19 so as to be reciprocatable along the second horizontal direction (X direction) orthogonal to the first horizontal direction (Y direction) within the horizontal plane through the paste supplying portion moving mechanism. Thereby, the paste supplying portion 26 can supply the paste 3 to the mask plate 16 while moving along the X direction.

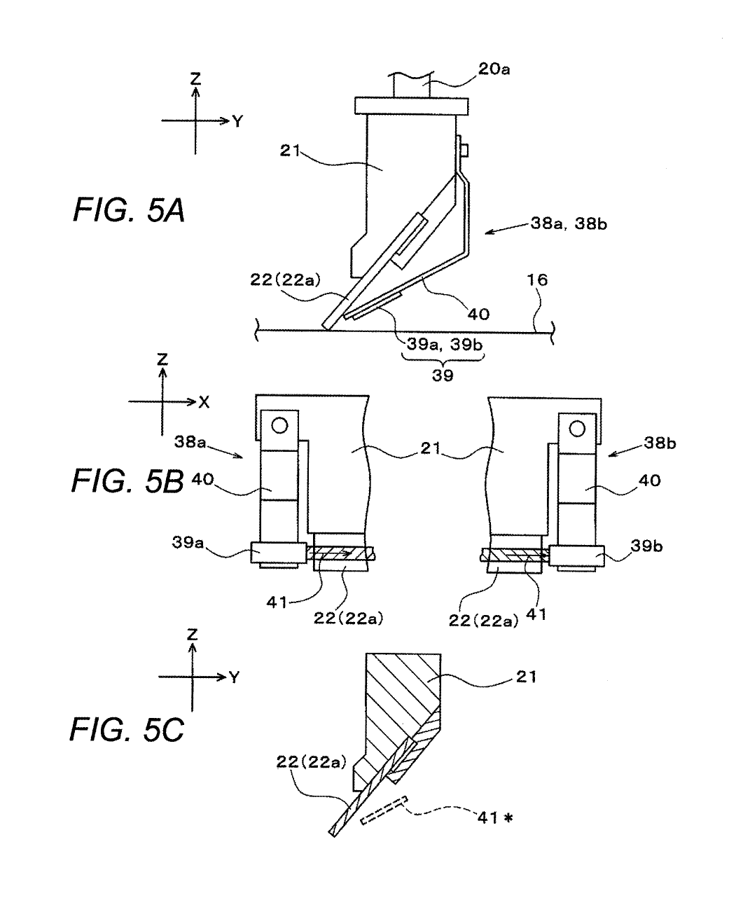

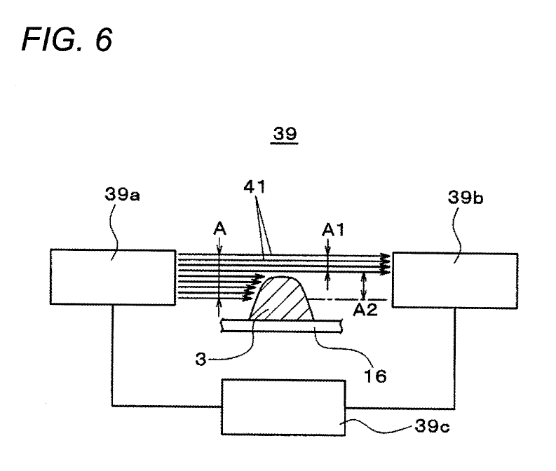

Next, referring to FIGS. 5A to 5C and 6, a remaining amount detecting sensor unit that detects the remaining amount of the paste 3 supplied to the mask plate 16 will be described. On both end portions of the squeegee holder 21 disposed on the front side, sensor units 38a and 38b are provided so as to be situated on a side toward the squeegeeing direction of the first squeegee 22a held by the squeegee holder 21. The sensor units 38a and 38b have a structure in which a light transmitting portion 39a and a light receiving portion 39b included in a sensor 39 are fixed to the squeegee holder 21 by bent-plate-form brackets 40. The light transmitting portion 39a and the light receiving portion 39b are connected to a controller 39c also included in the sensor 39 (FIG. 6). In FIG. 3, an illustration of the sensor units 38a and 38b is omitted.

The light transmitting portion 39a and the light receiving portion 39b are situated in positions facing each other in the X direction on the side toward the squeegeeing direction of the first squeegee 22a. In the process where belt-like test light 41 projected from the light transmitting portion 39a passes through a test cross-sectional area 41* shown by a broken line frame in FIG. 5C and is received by the light receiving portion 39b, the controller 39c measures the size of the paste 3 existing in the test cross-sectional area 41*. That is, when the paste 3 exists on the route where the test light 41 projected from the light transmitting portion 39a with an irradiation width A reaches the light receiving portion 39b as shown in FIG. 6, the light receiving portion 39b does not receive an irradiation width A2 corresponding to the size of the paste 3 and receives only a light reception width A1. The controller 39c measures the one-dimensional size of the paste 3 as a digital sensor value based on the result of light reception by the light receiving portion 39b. The device for measuring the size of the paste 3 is not limited to the above-mentioned one, and various structures may be adopted.

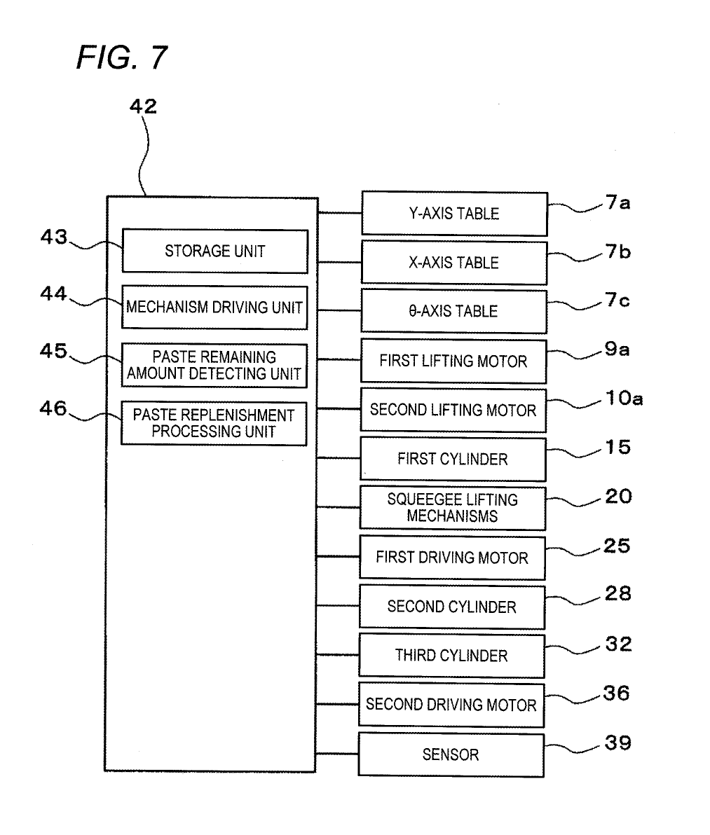

Next, referring to FIG. 7, the structure of the control system will be described. A control unit 42 of the screen printing apparatus 1 includes a storage unit 43, a mechanism driving unit 44, a paste remaining amount detecting unit 45 and a paste replenishment processing unit 46. The control unit 42 is connected to the Y-axis table 7a, the X-axis table 7b, the θ-axis table 7c, the first lifting motor 9a, the second lifting motor 10a, the first cylinder 15, the squeegee lifting mechanisms 20, the first driving motor 25, the second cylinder 28, the third cylinder 32, the second driving motor 36 and the sensor 39. The control unit 42 may include, e.g., a memory configured to store instructions; and at least one processor configured to execute the instructions to cause the screen printing apparatus 1 to provide at least one of the units provided in the control unit 42 or to execute at least one of the operations of the control unit 42.

The storage unit 43 stores paste remaining amount detection data and paste replenishment data as well as a printing operation program for executing screen printing and printing condition data. The paste remaining detection data are data necessary for detecting the remaining amount of the paste 3 based on the result of the measurement by the sensor 39. The paste replenishment data are data for executing paste replenishment based on the result of detection of the remaining amount of the paste 3, and include information on a threshold value for determining whether replenishment of the paste 3 is necessary or not.

The mechanism driving unit 44 is controlled by the control unit 42 and drives the mechanisms of the board positioning portion 4 and the paste printing portion 5. Thereby, conveyance, positioning and printing to be performed on the board 2 are executed. The paste remaining amount detecting unit 45 detects the remaining amount of the paste 3 on the mask plate 16 based on the result of the measurement by the sensor 39.

The paste replenishment processing unit 46 determines whether it is necessary to replenish the paste 3 to the mask plate 16 or not based on the result of detection of the remaining amount of the paste 3. When determining that it is necessary to replenish the paste 3, the paste replenishment processing unit 46 controls the mechanisms of the paste supplying portion 26 and the paste supplying portion moving mechanism. Thereby, paste replenish is executed.

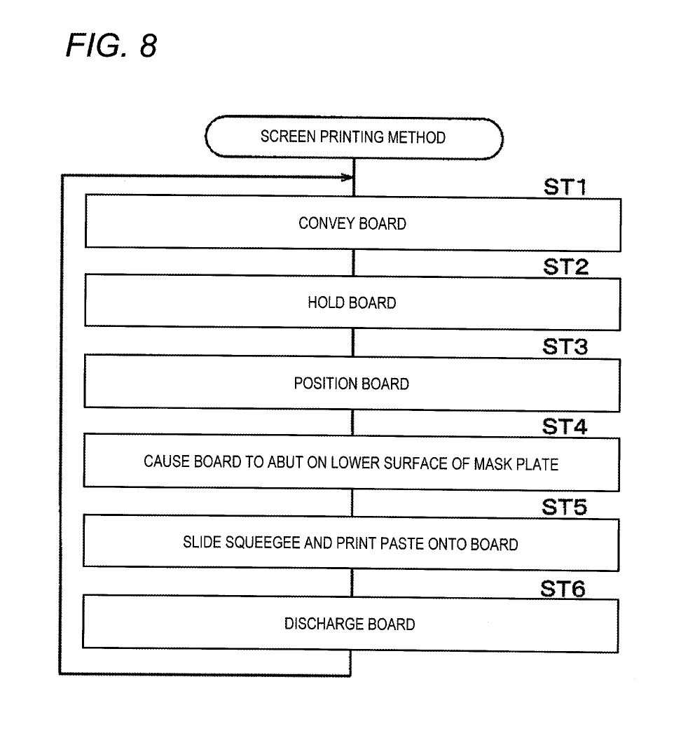

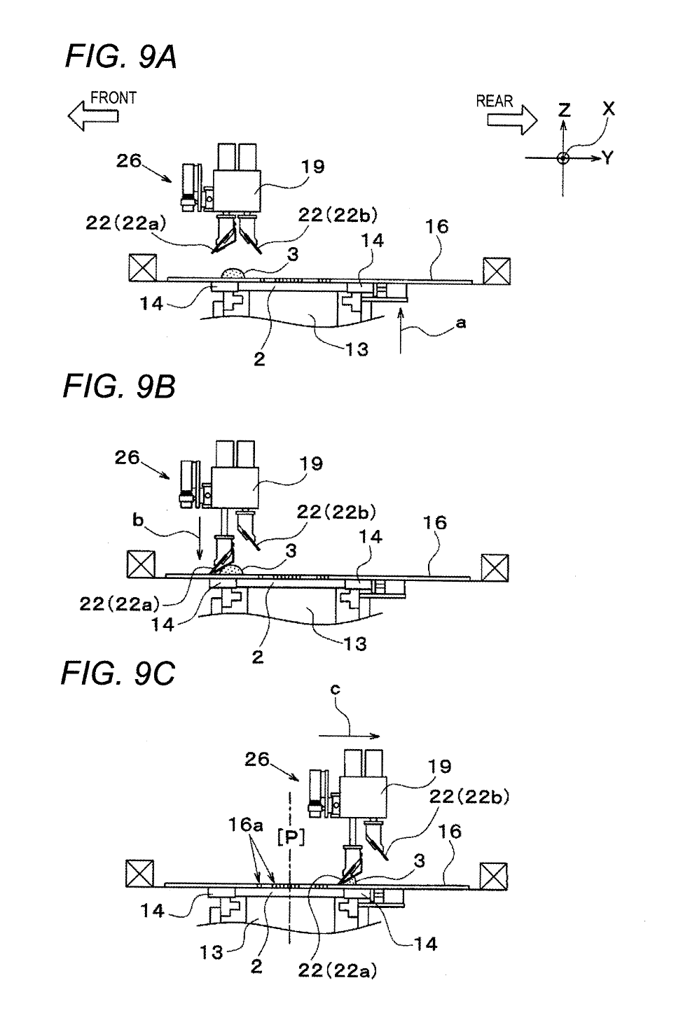

The screen printing apparatus 1 of the present embodiment is structured as described above. Next, a screen printing method will be described with reference to a flowchart of FIG. 8 and an operation explanatory views of FIGS. 9A to 9C.

First, the conveyers 12 convey the n-th board 2 to a predetermined position (ST1: board conveyance step). Then, the clamping member 14 holds the board 2 having moved up to a predetermined clamp position (ST2: board holding step). Then, the board positioning portion 4 positions the board 2 within the horizontal plane (ST3: board positioning step). Thereby, the electrodes 2a of the board 2 and the pattern holes 16a of the mask plate 16 coincide in the vertical direction. Then, as shown in FIG. 9A, the board supporting portion 13 moves up (arrow a) such that the board 2 abuts on the lower surface of the mask plate 16 (ST4: board abutment step).

Then, printing of the paste 3 is performed (ST5: printing step). That is, as shown in FIG. 9B, the first squeegee 22a moves down (arrow b) with respect to the mask plate 16 under a condition where the squeegee base 19 is moved forward. Then, as shown in FIG. 9C, the squeegee base 19 moves from the front toward the rear (arrow c) under a condition where the first squeegee 22a is in contact with the mask plate 16. Thereby, the first squeegee 22a slides on the mask plate 16, and the paste 3 previously supplied to the mask plate 16 is printed to the electrodes 2a of the board 2 through the pattern holes 16a. That is, at (ST5), the squeegee 22 together with the squeegee base 19 moves along the first horizontal direction and slides on the mask plate 16 in the squeegeeing direction along the first horizontal direction, whereby the paste 3 is printed onto the board 2 abutting on the lower surface of the mask plate 16 through the pattern holes 16a. Thereafter, the first squeegee 22a moves up.

After the paste 3 is printed onto the board 2, the board 2 is discharged (ST6: first board discharging step). That is, the board supporting portion 13 separates the board 2 from the mask plate 16 by moving down. Then, after the board 2 is released from the holding by the clamping member 14, the conveyers 12 convey the board 2 to the discharging position. Thereafter, the board 2 is discharged from the screen printing apparatus 1.

After the n-th board 2 is discharged, the process returns to (ST1), and the conveyers 12 convey the (n+1)-th board 2 to the predetermined position. Thereafter, the above-described steps are executed again. When the paste 3 is printed by using the second squeegee 22b, the second squeegee 22b is moved down so as to be in contact with the mask plate 16. Then, under this condition, the second squeegee 22b is slid from the rear toward the front.

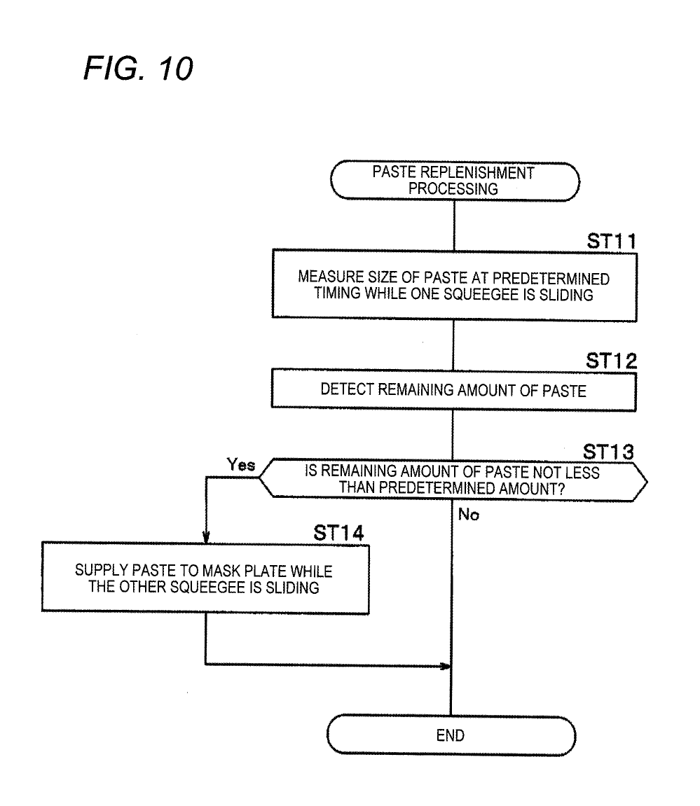

Next, referring to the flowchart of FIG. 10, paste replenish processing for replenishing the paste 3 to the mask plate 16 will be described. First, the sensor 39 measures the size of the paste 3 on the mask plate 16 at a predetermined timing while the first squeegee 22a is sliding from the front toward the rear (ST11: paste measurement step). The measurement timing is set, for example, to around the time when the first squeegee 22a passes a position [P] (FIG. 9C) corresponding to the center of the board 2 within the horizontal plane. Then, the control unit 42 (paste remaining amount detecting unit 45) detects the remaining amount of the paste 3 based on the measurement result (ST12: paste remaining amount detection step).

Then, the control unit 42 (paste replenishment processing unit 46) determines whether the remaining amount of the paste 3 is not less than a predetermined amount or not based on the result of detection of the remaining amount of the paste 3 (ST13: paste remaining amount determination step). When it is determined that the remaining amount of the paste 3 is not not less than the predetermined amount, the paste replenishment processing is ended. Moreover, when it is determined that the remaining amount of the paste 3 is not less than the predetermined amount, the paste supplying portion 26 supplies the paste 3 to the mask plate 16 while the second squeegee 22b is sliding (ST14: paste supply step).

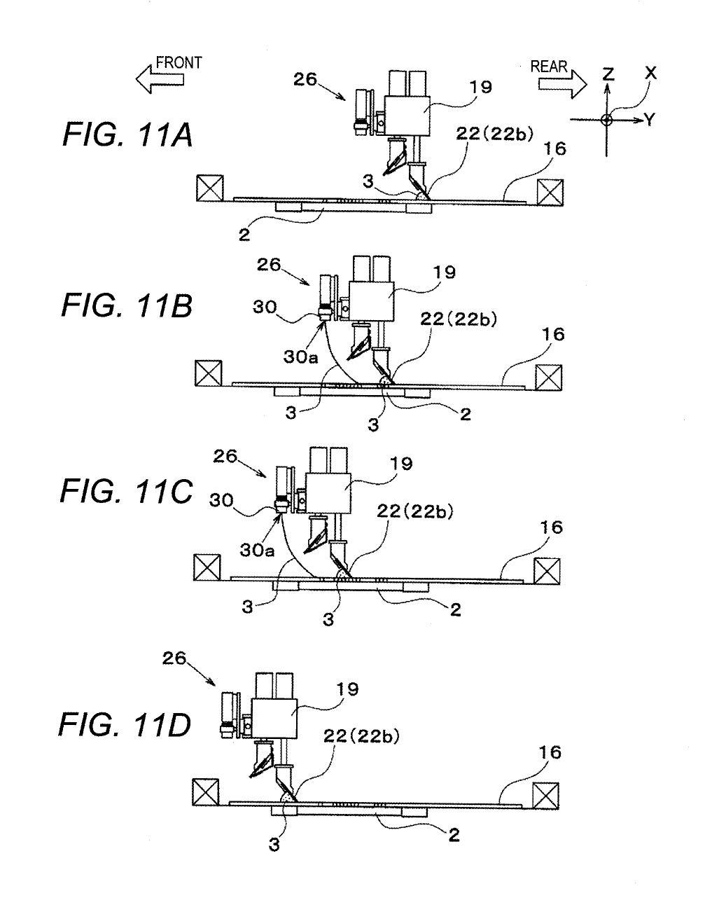

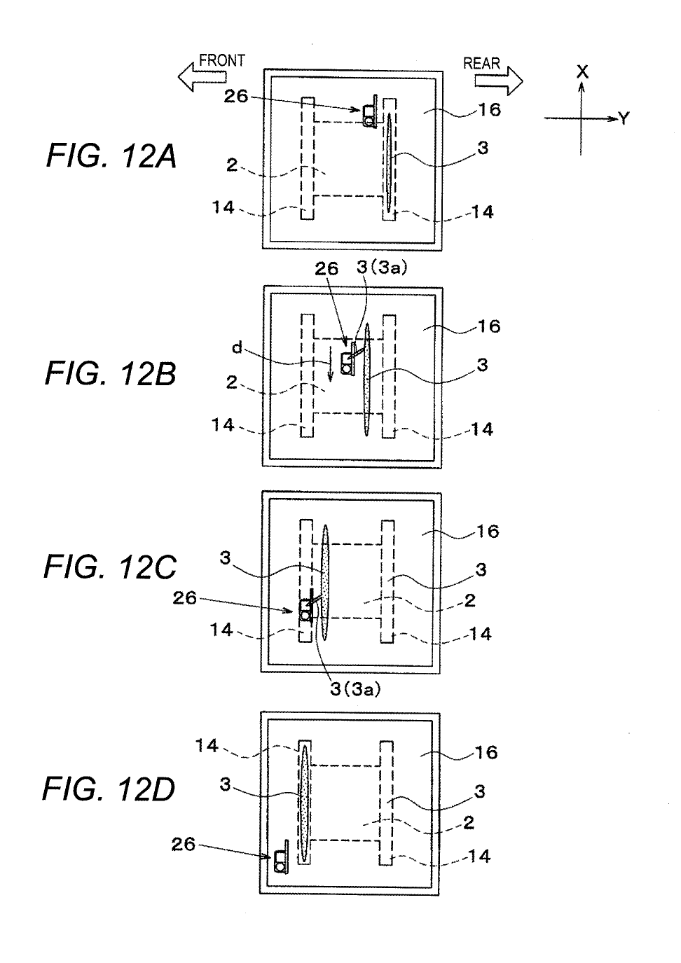

Hereinafter, referring to FIGS. 11A to 11D and 12A to 12D, a concrete operation of supplying the paste 3 will be described. FIGS. 12A, 12B, 12C and 12D correspond to FIGS. 11A, 11B, 11C and 11D, respectively, and show plan views of the mask plate 16. FIGS. 11A and 12A show a condition immediately before the second squeegee 22b in contact with the mask plate 16 starts sliding, and at this time, the paste supplying portion 26 is situated in advance at the one end portion (the upper side of the plane of FIG. 12A).

From the condition shown in FIGS. 11A and 12A, at a predetermined timing after the second squeegee 22b starts sliding from the rear toward the front, the paste supplying portion 26 ejects the paste 3 from the ejection port 30a of the pot 30 while moving along the X direction (FIG. 11B to FIG. 11C). That is, at the printing step (ST5), while the squeegee 22 (the second squeegee 22b) is sliding on the mask plate 16, the paste supplying portion 26 supplies the paste 3 to the mask plate 16 while moving along the second horizontal direction (X direction). As described above, in the present embodiment, printing of the paste 3 to the board 2 and replenishment of the paste 3 to the mask plate 16 are performed in parallel.

Thereby, as shown in FIGS. 12B and 12C, new paste 3a ejected from the ejection port 30a is supplied in a slanting direction (a direction intersecting the squeegeeing direction of the second squeegee 22b) on the mask plate 16. The new paste 3a supplied to the mask plate 16 through the ejection port 30a is scraped by the second squeegee 22b sliding on the mask plate 16 and intermixed with the old paste 3 remaining on the mask plate 16. Then, as shown in FIGS. 11D and 12D, the paste supplying portion 26 stops the supply of the paste 3 at a given timing where the second squeegee 22b is moved to the front.

By supplying the paste 3 according to the above-described embodiment, the following advantages can be obtained. First, it is unnecessary to stop printing (in other words, sliding of the squeegee 22) in order to replenish the paste 3, so that reduction in productivity can be suppressed. Moreover, by supplying the paste 3 while moving along the X direction orthogonal to the squeegeeing direction of the second squeegee 22b, the paste supplying portion 26 can uniformly disperse the paste 3 over a longitudinal direction of the second squeegee 22b. Further, since the paste 3a newly supplied onto the mask plate 16 is agitated by the sliding of the second squeegee 22b to be intermixed with the already blended old paste 3, the paste 3a can be quickly blended. Regarding this, it is unnecessary to blend the new and old pastes 3 by agitating them by reciprocating the squeegee 22 before screen printing is started, so that further reduction in productivity can be suppressed.

The paste supplying portion 26 may move while repeating ejecting and stopping of the paste 3. The paste supply start timing may be before the start of sliding of the second squeegee 22b. Further, the paste supplying portion 26 may supply the paste 3 while reciprocating. In sum, the paste 3 may be supplied by the paste supplying portion 26 while the second squeegee 22b is sliding.

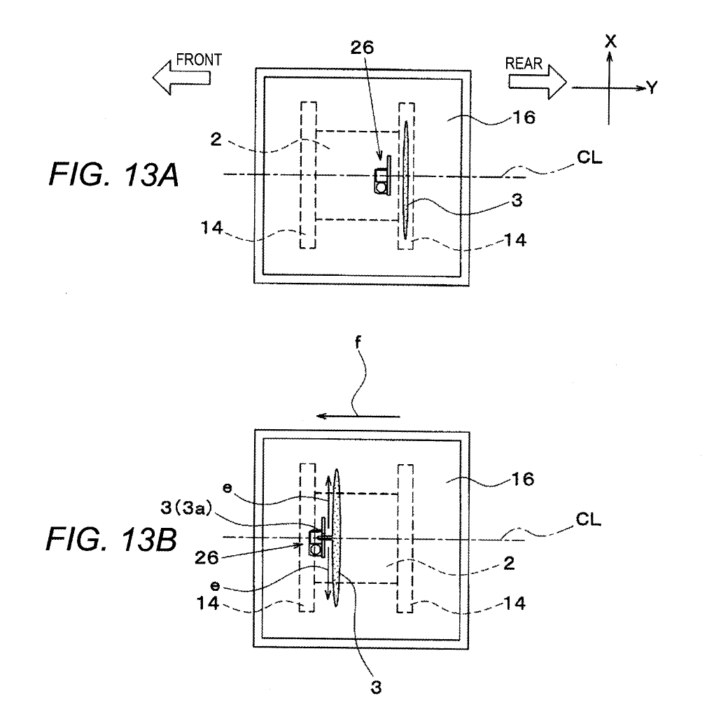

Next, referring to FIGS. 13A and 13B, another embodiment will be described. FIG. 13A shows a condition where the ejection port 30a of the paste supplying portion 26 is arranged in the neighborhood of a line CL passing the center of the board 2 within the horizontal plane in the Y direction with the board 2 abutting on the lower surface of the mask plate 16. Under this condition, as shown in FIG. 13B, the paste supplying portion 26 supplies the paste 3 to the mask plate 16 while the squeegee 22 (the second squeegee 22b) is sliding on the mask plate 16 (arrow f). That is, in this example, the paste 3 is supplied without the paste supplying portion 26 being moved along the X direction, and the new paste 3a is supplied onto the line CL. Then, the new paste 3a supplied onto the mask plate 16 gradually spreads along the longitudinal direction of the second squeegee 22b while being scraped by the second squeegee 22b (arrow e). That is, when the paste 3 is supplied according to this embodiment, an advantage can also be expected in that the new paste 3a is dispersed along the longitudinal direction of the second squeegee 22b without remaining in the neighborhood of the line CL.

The screen printing apparatus and the screen printing method of the present invention are not limited to the present embodiments but may be modified without departing from the scope of the invention. For example, a sensor unit may be provided to the second squeegee 22b so that whether it is necessary to replenish paste or not is determined based on the result of the measurement by the sensor unit. In this case, the first squeegee 22a is slid from the front toward the rear, and while the second squeegee 22b is being slid from the rear toward the front thereafter, the paste 3 is supplied. Moreover, it is sufficient for the paste supplying portion 26 to have a structure capable of supplying the paste 3 to the mask plate 16, and for example, a syringe accommodating the paste 3 may be used as the paste supplying portion 26.

According to one or more embodiments of the present invention, paste can be supplied onto the mask plate while reduction in productivity is prevented, which is useful in the field of electronic component mounting.

What is claimed is:

1. A screen printing apparatus comprising:
a mask plate having a pattern hole formed according to an arrangement of an electrode of a board;
a squeegee base that moves along a first horizontal direction above the mask plate;
a squeegee that is held by the squeegee base, and prints paste through the pattern hole onto the board abutting on a lower surface of the mask plate by moving together with the squeegee base and sliding on the mask plate in a squeegeeing direction along the first horizontal direction; and
a paste supplying portion that moves together with the squeegee base and supplies the paste to the mask plate,
wherein the paste supplying portion supplies the paste to the mask plate while the squeegee is sliding on the mask plate.

2. The screen printing apparatus according to claim 1,
wherein the paste supplying portion is attached to the squeegee base so as to be reciprocatable along a second horizontal direction orthogonal to the first horizontal direction within a horizontal plane, and
wherein while the squeegee is sliding on the mask plate, the paste supplying portion supplies the paste to the mask plate while moving along the second horizontal direction.

3. The screen printing apparatus according to claim 1,
wherein the paste supplying portion has an ejection port that ejects the paste ahead of the squeegee in the squeegeeing direction, and
wherein the paste supplied to the mask plate through the ejection port is scraped by the squeegee which is sliding on the mask plate.

4. A screen printing method for printing paste onto a board by a squeegee held by a squeegee base that moves along a first horizontal direction above a mask plate having a pattern hole formed according to an arrangement of an electrode of the board, the method comprising:
causing the board to abut on a lower surface of the mask plate; and
printing the paste through the pattern hole onto the board abutting on the lower surface of the mask plate by the squeegee which is moving together with the squeegee base and sliding on the mask plate in a squeegeeing direction along the first horizontal direction,
wherein while the squeegee is sliding on the mask plate, the paste is supplied to the mask plate from a paste supplying portion which is moving together with the squeegee base.

5. The screen printing method according to claim 4,
wherein the paste supplying portion is attached to the squeegee base so as to be reciprocatable along a second horizontal direction orthogonal to the first horizontal direction within a horizontal plane, and
wherein in the printing step, while the squeegee is sliding on the mask plate, the paste supplying portion supplies the paste to the mask plate while moving along the second horizontal direction.

6. The screen printing method according to claim 4,
wherein the paste supplying portion has an ejection port that ejects the paste ahead of the squeegee in the squeegeeing direction, and
wherein the paste supplied to the mask plate through the ejection port is scraped by the squeegee which is sliding on the mask plate.
